(19) United States
(12) Patent Application Publication
(10) Pub. No.: US 2026/0341851 A1
(43) Pub. Date: Oct. 29, 2026

(54) Battery Case and Secondary Battery Including the Same

(71) Applicant: LG Energy Solution, Ltd., Seoul (KR)

(72) Inventor: Hyun Woong Yun, Daejeon (KR)

(73) Assignee: LG Energy Solution, Ltd., Seoul (KR)

(21) Appl. No.: 19/703,553

(22) Filed: Jun. 10, 2026

Related U.S. Application Data
(63) Continuation of application No. PCT/KR2025/005262, filed on Apr. 17, 2025.

(30) Foreign Application Priority Data
May 20, 2024 (KR) 10-2024-0065145

(51) Int. Cl. H01M 50/129; H01M 50/105; H01M 50/119; H01M 50/121; H01M 50/46

(52) U.S. Cl. CPC H01M 50/129; H01M 50/105; H01M 50/119; H01M 50/121; H01M 50/46

(57) ABSTRACT

A battery case having excellent durability and a secondary battery including the same are disclosed. The battery case includes: (1) a first polymer layer; (2) a second polymer layer; and (3) a gas barrier layer disposed between the first polymer layer and the second polymer layer. The battery case further includes at least one cup portion curved in one direction, wherein a K value according to a following Equation (1) as described herein is 63.0 or more.

### CROSS REFERENCE TO RELATED APPLICATIONS

This application is a bypass continuation of International Application No. PCT/KR2025/005262, which was filed on Apr. 17, 2025, and claims priority from Korean Patent Application No. 10-2024-0065145, filed on May 20, 2024, the disclosures of which are incorporated by reference herein.

### TECHNICAL FIELD

The present disclosure relates to a battery case having excellent durability and a secondary battery including the same.

### BACKGROUND

A secondary battery is generally prepared by a method in which electrode active material slurries are applied onto a positive electrode collector and a negative electrode collector to prepare a positive electrode and a negative electrode, respectively, the positive electrode and the negative electrode are stacked on both sides of a separator to form an electrode assembly having a predetermined shape, the electrode assembly is then accommodated in a battery case, and an electrolyte solution is injected.

If a thickness of the electrode assembly increases, that is, if a greater number of the electrodes are stacked, since more active material may be included, capacity of the battery may be increased. However, in a case in which thickness and configuration of the battery case are not properly adjusted accordingly, problems, such as cracks and corrosion, are likely to occur at an edge portion.

Thus, there is a need to develop a battery case having excellent durability while being able to accommodate a thick, high-capacity electrode assembly.

### Summary Technical Problem

An aspect of the present disclosure provides a battery case designed such that a thickness of each layer and a depth of a cup portion satisfy a specific equation and a secondary battery in which durability is improved by including the battery case.

### Technical Solution

[1] The present disclosure provides a battery case including a first polymer layer, a second polymer layer, and a gas barrier layer disposed between the first polymer layer and the second polymer layer, and
including at least one cup portion curved in one direction,
wherein a K value according to Equation (1) is 63.0 or more.

K=P/C+50D Equation (1):

In Equation (1),
P is a thickness value of the battery case which is measured in μm,
C is a depth value of the cup portion which is measured in mm, and
D is a ratio of a thickness of the gas barrier layer to a total thickness of the first polymer layer and the second polymer layer.
[2] The present disclosure provides the battery case of [1] above, wherein the battery case has a thickness of 100 μm to 1,000 μm.
[3] The present disclosure provides the battery case of [1] or [2] above, wherein the cup portion has a depth of 1 mm to 70 mm.
[4] The present disclosure provides the battery case of at least one of [1] to [3] above, wherein P/C of Equation (1) is 19.5 or more.
[5] The present disclosure provides the battery case of at least one of [1] to [4] above, wherein the first polymer layer has a thickness of 10 μm to 300 μm.
[6] The present disclosure provides the battery case of at least one of [1] to [5] above, wherein the second polymer layer has a thickness of 10 μm to 300 μm.
[7] The present disclosure provides the battery case of at least one of [1] to [6] above, wherein the gas barrier layer has a thickness of 50 μm to 900 μm.
[8] The present disclosure provides the battery case of at least one of [1] to [7] above, wherein the gas barrier layer includes at least one metal selected from stainless steel (SUS), nickel (Ni), iron (Fe), cobalt (Co), chromium (Cr), molybdenum (Mo), tantalum (Ta), tungsten (W), titanium (Ti), and rhenium (Re); or an alloy of the metal and aluminum (Al).
[9] The present disclosure provides the battery case of at least one of [1] to [8] above, wherein D of Equation (1) is 0.80 or more.
[10] The present disclosure provides a secondary battery including: an electrode assembly including a positive electrode, a negative electrode, and a separator disposed between the positive electrode and the negative electrode; an electrolyte; and the battery case of at least one of [1] to [9] above, wherein the electrode assembly and the electrolyte are accommodated in a cup portion of the battery case.
[11] The present disclosure provides the secondary battery of [10] above, wherein the secondary battery has an S value according to Equation (2) of 37.0 or more.

S=P/T×N+20D Equation (2):

In Equation (2),
P is a thickness value of the battery case which is measured in μm,
T is a thickness value of the electrode assembly which is measured in mm, wherein, when two or more electrode assemblies are included, T is a sum of thickness values of the two or more electrode assemblies,
N is the number of cup portions in the battery case, and
D is a ratio of a thickness of the gas barrier layer to a total thickness of the first polymer layer and the second polymer layer.
[12] The present disclosure provides the secondary battery of [10] or [11] above, wherein the electrode assembly has a thickness of 1 mm to 150 mm.

### Advantageous Effects

A battery case according to the present disclosure is configured such that a thickness of each layer constituting the battery case satisfies a specific equation by reflecting a depth of a cup portion, wherein since there is a low possibility of cracks occurring at an edge portion even if a thick electrode assembly is accommodated, it has an advantage of preventing corrosion issues caused by such cracks.

### BRIEF DESCRIPTION OF THE DRAWINGS

FIG. 1 is a view illustrating a cross-sectional structure of a pouch film laminate according to an aspect.

FIG. 2 and FIG. 3 are views illustrating a structure of a battery case according to an aspect, respectively.

FIG. 4 is a view illustrating a structure of an electrode assembly according to an aspect.

DETAILED DESCRIPTION Hereinafter, the present disclosure will be described in more detail.

Recently, rated capacity of a secondary battery is increasing as demand for batteries requiring high capacity, such as batteries for electric vehicles, increases. Accordingly, there is a trend toward an increase in size and thickness of an electrode assembly, and a thickness of a battery case also needs to increase in line with this trend.

For example, in a pouch type secondary battery, in a case in which a pouch is formed deeper to match the increased thickness of the electrode assembly, since more stretching occurs, a thickness of the pouch is decreased. If charge and discharge are repeated in this state, cracks may occur as a force is applied to the pouch which has become thin due to expansion/contraction of the electrode assembly, and this may lead to problems such as electrolyte solution leakage and corrosion of the battery.

Accordingly, these problems may be prevented by increasing the thickness of the battery case, but in a case in which the thickness of the battery case is increased indiscriminately, since there is a concern that energy density and durability of the case are reduced, there is a need to establish a standard so that a thickness of each layer constituting the battery case may be appropriately selected by reflecting the thickness of the electrode assembly.

Thus, the present inventors have found that excellent durability may be achieved when a depth of a cup portion, in which the electrode assembly is to be accommodated, and the thickness of each layer constituting the battery case satisfy a specific condition, thereby leading to the completion of the present disclosure.

A battery case according to the present disclosure is characterized in that it includes a first polymer layer, a second polymer layer, and a gas barrier layer disposed between the first polymer layer and the second polymer layer, and includes at least one cup portion curved in one direction, wherein a K value according to Equation (1) below is 63.0 or more.

K=P/C+50D Equation (1):

In Equation (1),
P is a thickness value of the battery case which is measured in μm,
C is a depth value of the cup portion which is measured in mm, and
D is a ratio of a thickness of the gas barrier layer to a total thickness of the first polymer layer and the second polymer layer.

The K value according to Equation (1) may be 63.0 or more, preferably 70.0 or more, and more preferably 75.0 or more. However, considering energy density of a cell and insulation properties of the case, it is desirable that the K value is 500.0 or less, 300.0 or less, or 120.0 or less. If the K value is 63.0 or more, since the gas barrier layer with a sufficient thickness is achieved when considering the depth of the cup portion and the total thickness of the battery case, occurrence of cracks in the battery case due to an external force may be prevented.

Specifically, if a P/C value of Equation (1) decreases, that is, when the depth of the cup portion relative to the thickness of the battery case increases, there is a need to enhance durability of the battery case by increasing a D value, that is, the thickness of the gas barrier layer relative to the polymer layer. Since the gas barrier layer includes a metallic component, increasing its thickness relative to the polymer layer is advantageous for improving the durability of the battery case.

In contrast, in a case in which the thickness ratio of the gas barrier layer to the polymer layer is excessively increased to increase the durability, since problems, such as a reduction in sealing strength or dielectric breakdown due to damage to the outer polymer layer, may occur, deep forming of the cup portion may be limited.

Accordingly, the present disclosure is significant in that it provides a standard for determining how much the thickness of each layer constituting the battery case must be adjusted according to the depth of the cup portion through the K value according to Equation (1) to achieve excellent performance.

Hereinafter, each component of the present disclosure will be described in more detail.

### <Battery Case>

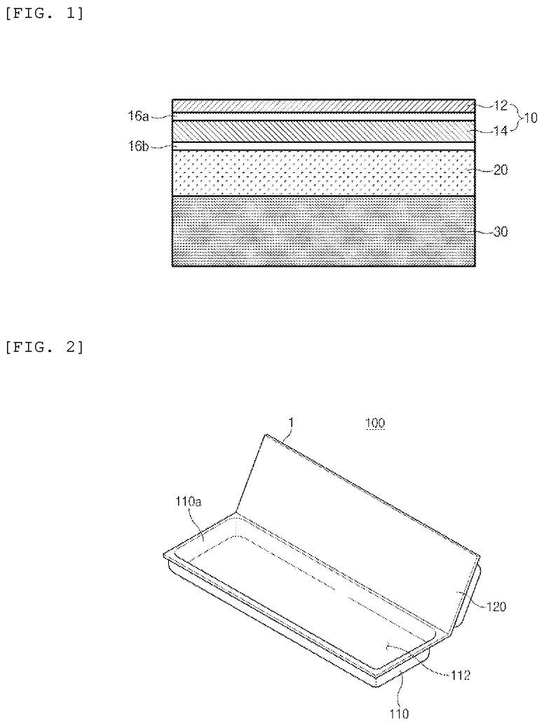

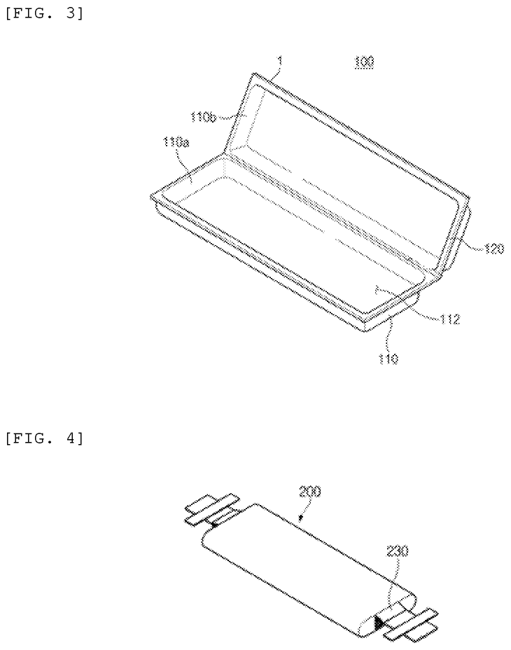

The battery case according to the present disclosure will be described with reference to FIG. 1, FIG. 2, and FIG. 3.

The battery case according to the present disclosure includes a first polymer layer 10, a second polymer layer 30, and a gas barrier layer 20 disposed between the first polymer layer 10 and the second polymer layer 30, and specifically, is prepared by forming a pouch film laminate 1 in which the first polymer layer 10, the gas barrier layer 20, and the second polymer layer 30 are sequentially provided, wherein the battery case includes at least one cup portion 110a and 110b. FIG. 1 illustrates a cross-sectional structure of the pouch film laminate 1.

Aspects of the battery case according to the present disclosure are illustrated in FIG. 2 and FIG. 3. The cup portions 110a and 110b include a space 112 for accommodating an electrode assembly (not shown) and an electrolyte (not shown), wherein it is prepared by drawing a pouch film laminate 1 using a punch or the like. In this case, the drawing may be performed by pressing a punch toward the second polymer layer of the pouch film laminate 1.

The battery case 100 may include one cup portion 110a as illustrated in FIG. 2, or may include two cup portions 110a and 110b as illustrated in FIG. 3.

The battery case 100 according to the present disclosure includes a lower case 110 and an upper case 120, and the cup portion 110a and 110b may be formed in only one of the lower case 110 and the upper case 120 (see FIG. 2), or may be formed in both of them (see FIG. 3). In a case in which the pouch film laminate 1 is formed by a 1-cup forming device, a battery case having one cup portion may be prepared as illustrated in FIG. 2, and in a case in which the pouch film laminate 1 is formed by a 2-cup forming device, a battery case having cup portions formed in both the lower case 110 and the upper case 120 may be prepared as illustrated in FIG. 3.

According to an aspect of the present disclosure, the thickness of the battery case refers to a thickness of the pouch film laminate, wherein it may be in a range of 100 μm to 1,000 μm, particularly 110 μm to 900 μm, and more particularly 120 μm to 700 μm.

Also, the depth of the cup portion may be changed according to a thickness of the electrode assembly to be accommodated, but, for example, may be 1 mm or more, particularly 3 mm or more, and more particularly 7 mm or more, and may be 70 mm or less, particularly 60 mm or less, and more particularly 50 mm or less.

P/C of Equation (1) may be 19.5 or more, preferably, 23.0 or more. In a case in which the P/C value is 19.5 or more, since the thickness of the battery case is sufficiently secured when considering the depth of the cup portion, there is an advantage in that a proportion occupied by the gas barrier layer in the pouch film laminate may be reduced. However, considering the energy density of the cell, it is desirable that P/C is 250.0 or less, specifically, 100.0 or less.

Hereinafter, each layer of the battery case will be described in detail.

### First Polymer Layer

The first polymer layer 10 is disposed as an outermost layer of the battery case to protect the electrode assembly from external impact and electrically insulate it, wherein, for example, it may be formed of at least one polymer material selected from the group consisting of polyethylene, polypropylene, polycarbonate, polyethylene terephthalate, polyvinyl chloride, acrylic polymer, polyacrylonitrile, polyimide, polyamide, cellulose, aramid, Nylon, polyester, polyparaphenylene benzobisoxazole, polyarylate, and Teflon.

The first polymer layer 10 may have a single-layer structure, or may have a multilayer structure in which different polymer films 12 and 14 are laminated as illustrated in FIG. 1. In a case in which the first polymer layer 10 has the multilayer structure, adhesive layers 16a, 16b may be disposed between the polymer films.

The first polymer layer 10 may have a thickness of 10 μm to 300 μm, preferably 20 μm to 250 μm, and more preferably 30 μm to 200 μm. That the thickness of the first polymer layer is 10 μm or more is advantageous in terms of durability. However, since formability may be reduced if the first polymer layer is excessively thick, it is desirable that the thickness of the first polymer layer is 300 μm or less. The above thickness is a thickness including the adhesive layer 16a when the first polymer layer 10 has the multilayer structure.

In a preferred aspect, the first polymer layer 10 may be a laminate of a polyethylene terephthalate (PET) film and a Nylon film. In this case, it is desirable that the Nylon film is disposed toward the gas barrier layer 20, i.e., on an inner side, and the PET film is disposed toward a surface of the battery case.

Since polyethylene terephthalate (PET) has excellent durability and electrical insulation properties, the durability and insulation properties are excellent when the PET film is disposed toward the surface. However, with respect to the PET film, since adhesion to an aluminum alloy thin film constituting the gas barrier layer 20 is weak and a stretching behavior is also different, when the PET film is disposed toward the gas barrier layer, delamination between a base material layer and the gas barrier layer may occur during a forming process and a problem may occur in which the formability is reduced due to non-uniform stretching of the gas barrier layer. In contrast, since the Nylon film has a similar stretching behavior to the aluminum alloy thin film constituting the gas barrier layer 20, an effect of improving the formability may be obtained when the Nylon film is disposed between the polyethylene terephthalate and the gas barrier layer.

### Gas Barrier Layer

The gas barrier layer 20 is to secure mechanical strength of the battery case, block incoming and outgoing of gas or moisture from the outside of the secondary battery, and prevent leakage of an electrolyte.

Since the formability improves as the thickness of the gas barrier layer increases, a critical forming depth is increased and resistance to external stress after forming is improved, and thus, the gas barrier layer may have a thickness of 50 μm or more, preferably 70 μm or more, and more preferably 100 μm or more. However, since the energy density of the cell may decrease as the thickness of the gas barrier layer increases, the thickness of the gas barrier layer may be 900 μm or less, preferably 700 μm or less, and more preferably 500 μm or less.

The gas barrier layer may include at least one metal selected from stainless steel (SUS), nickel (Ni), iron (Fe), cobalt (Co), chromium (Cr), molybdenum (Mo), tantalum (Ta), tungsten (W), titanium (Ti), and rhenium (Re); or may include an alloy of the metal and aluminum (Al), and may specifically be formed of an aluminum alloy thin film.

Preferably, the aluminum alloy thin film may have an iron (Fe) content of 1.2 wt % to 1.7 wt %, preferably 1.3 wt % to 1.7 wt %, and more preferably 1.3 wt % to 1.45 wt %. In a case in which the iron (Fe) content in the aluminum alloy thin film is 1.2 wt % or more, occurrence of cracks and pinholes during forming may be prevented by increasing strength of the aluminum alloy thin film. However, considering flexibility, formability, and bendability, it is desirable that the iron (Fe) content is 1.7 wt % or less.

### Second Polymer Layer

The second polymer layer 30 is for sealing the battery case by being bonded through thermal compression, wherein it is disposed as an innermost layer of the battery case.

The second polymer layer 30 must have insulation properties and corrosion resistance because it is a surface that is in contact with the electrolyte and the electrode assembly after cell assembly, and, since the second polymer layer completely seals the inside to block material movement between the inside/the outside, it must have high sealing properties.

The second polymer layer 30, for example, may be formed of at least one selected from the group consisting of polyethylene, polypropylene, polycarbonate, polyethylene terephthalate, polyvinyl chloride, acrylic polymer, polyacrylonitrile, polyimide, polyamide, cellulose, aramid, nylon, polyester, polyparaphenylene benzobisoxazole, polyarylate, and Teflon, and, among them, it is particularly desirable to include polypropylene (PP) which has excellent mechanical properties, such as tensile strength, stiffness, surface hardness, wear resistance, and heat resistance, and excellent chemical properties such as corrosion resistance.

More specifically, the second polymer layer 30 may include polypropylene, cast polypropylene (CPP), acid modified polypropylene, a polypropylene-butylene-ethylene copolymer, or a combination thereof.

The second polymer layer 30 may have a single-layer structure, or may have a multilayer structure including two or more layers formed of different polymer materials.

The second polymer layer 30 may have a thickness of 10 μm to 300 μm, preferably 20 μm to 250 μm, and more preferably 30 μm to 200 μm. That the thickness of the second polymer layer is 30 μm or more is advantageous in terms of sealing durability and insulation properties. However, since the bendability may be reduced if the second polymer layer is excessively thick, it is desirable that the thickness of the second polymer layer is 300 μm or less.

D of Equation (1), that is, the ratio of the thickness of the gas barrier layer to the total thickness of the first polymer layer and the second polymer layer may be 0.80 or more, preferably 1.00 or more, and more preferably 1.20 or more. Since this means that the gas barrier layer, i.e., the metal layer accounts for a large proportion of the battery case, excellent durability may be secured even if a relatively thicker electrode assembly is accommodated when the D value is designed as described above. That is, even if the P/C value of Equation (1) decreases, it becomes easy to adjust the K value to 63.0 or more. However, considering the insulation properties of the case, it is desirable that D is 9.00 or less, particularly 5.00 or less, and more particularly 2.50 or less.

### <Secondary Battery>

Hereinafter, a secondary battery including the above battery case will be described.

A secondary battery according to an aspect of the present disclosure includes an electrode assembly including a positive electrode, a negative electrode, and a separator disposed between the positive electrode and the negative electrode; an electrolyte; and the battery case, wherein the electrode assembly and the electrolyte are accommodated in a cup portion of the battery case.

Specifically, referring to FIG. 2 and FIG. 3, after the electrode assembly is accommodated in the cup portions 110a and 110b and an electrolyte solution is injected, the electrode assembly and the electrolyte may be isolated from the outside by folding the upper case 120 such that it is on an upper end of the lower case 110. Then, the secondary battery may be prepared by performing a sealing process through thermal compression of corner portions of the upper case 120 and the lower case 110.

The secondary battery according to the aspect of the present disclosure may have an S value according to Equation (2) below of 37.0 or more, 40.0 or more, or 45.0 or more, and in this case, it is desirable that the durability of the battery case is appropriately secured when considering the thickness of the electrode assembly. However, considering energy density and insulation properties, the S value may be 400.0 or less, 300.0 or less, or 85.0 or less.

S=P/T×N+20D Equation (2):

In Equation (2),
P is a thickness value of the battery case which is measured in μm,
T is a thickness value of the electrode assembly which is measured in mm, wherein, when two or more electrode assemblies are included, T is a sum of thickness values thereof,
N is the number of cup portions in the battery case, and
D is a ratio of a thickness of the gas barrier layer to a total thickness of the first polymer layer and the second polymer layer.

Since the battery case has been described in detail above, the electrode assembly and the electrolyte will be described in more detail below.

### Electrode Assembly

In the present disclosure, it is desirable that the electrode assembly is a stacked-type electrode assembly having a structure in which a positive electrode and a negative electrode are sequentially stacked with a separator therebetween. The present disclosure is suitable for using the stacked-type electrode assembly because it solves the problem of battery case damage that occurs when the electrode assembly becomes thick while utilizing a capacity improvement effect that may be obtained by stacking the electrodes in parallel.

A thickness of the electrode assembly may be in a range of 1 mm to 150 mm, particularly 3 mm to 120 mm, and more particularly 7 mm to 100 mm.

As illustrated in FIG. 4, the electrode assembly 200 may include a plurality of electrode tabs 230 welded to each other. The plurality of electrode tabs 230 may be connected to a plurality of electrodes, and may protrude from the electrode assembly 200 to the outside so that they may act as a path through which electrons may move between the inside and the outside of the electrode assembly 200.

The electrode tab 230 connected to the positive electrode and the electrode tab 230 connected to the negative electrode may protrude in different directions with respect to the electrode assembly 200. However, the present disclosure is not limited thereto, and it is also possible for the electrode tab 230 connected to the positive electrode and the electrode tab 230 connected to the negative electrode to protrude in the same direction side by side.

The positive electrode, the negative electrode, the separator, and the electrolyte may be used in the present disclosure without limitation as long as they are commonly used in a secondary battery, but the following description may be referred to as a preferred example.

The positive electrode is a sheet-type positive electrode, wherein it may include a positive electrode collector formed of a metal thin sheet with excellent conductivity, for example, an aluminum foil, and a positive electrode active material layer coated on one surface or both surfaces thereof. The negative electrode is a sheet-type negative electrode, wherein it may include a negative electrode collector formed of a metal thin sheet with excellent conductivity, for example, a copper (Cu) or nickel (Ni) foil, and a negative electrode active material layer coated on one surface or both surfaces thereof.

The positive electrode active material layer may include a lithium metal oxide including lithium and a transition metal, such as cobalt, manganese, and/or nickel, as a positive electrode active material, and may further include a conductive agent and/or a binder, if necessary. Various materials commonly used in the preparation of a secondary battery may be used without limitation as the positive electrode active material, the conductive agent, and the binder.

Specifically, the positive electrode may include at least one selected from the group consisting of a lithium nickel-based composite oxide, a lithium manganese-based composite oxide, and a lithium iron phosphate-based composite oxide as a positive electrode active material, and may preferably include a lithium nickel-based composite oxide, and the lithium nickel-based composite oxide may be represented by Formula 1 below.

Li₁₊ₓ(NiₐCo_{b}Mn_{c}M_{d})O₂ [Formula 1]

In Formula 1,
M is at least one selected from the group consisting of tungsten (W), copper (Cu), iron (Fe), vanadium (V), chromium (Cr), titanium (Ti), zirconium (Zr), zinc (Zn), aluminum (Al), indium (In), tantalum (Ta), yttrium (Y), lanthanum (La), strontium (Sr), gallium (Ga), scandium (Sc), gadolinium (Ga), samarium (Sm), calcium (Ca), cerium (Ce), niobium (Nb), magnesium (Mg), boron (B), and molybdenum (Mo), and
−0.4≤x≤0.4, 0.30≤a≤1, 0≤b≤0.70, 0≤c≤0.70, 0≤d≤0.10, and a+b+c+d=1.

1+x represents a molar ratio of lithium in the lithium nickel-based composite oxide, wherein x may satisfy-0.1≤x≤0.2, or 0≤x≤0.2. When the molar ratio of the lithium satisfies the above range, a crystal structure of the lithium nickel-based composite oxide may be stably formed.
a represents a molar ratio of nickel among total metals excluding lithium in the lithium nickel-based composite oxide, wherein a may satisfy 0.70≤a<1, 0.80≤a<1, or 0.90≤a<1. When the molar ratio of the nickel satisfies the above range, high energy density may be exhibited to achieve high capacity.

b represents a molar ratio of cobalt among the total metals excluding lithium in the lithium nickel-based composite oxide, wherein b may satisfy 0<b≤0.25, 0<b≤0.15, or 0<b≤0.05. When the molar ratio of the cobalt satisfies the above range, good resistance characteristics and output characteristics may be achieved.

c represents a molar ratio of manganese among the total metals excluding lithium in the lithium nickel-based composite oxide, wherein c may satisfy 0<c≤0.25, 0<c≤0.15, or 0<c≤0.05. When the molar ratio of the manganese satisfies the above range, structural stability of the positive electrode active material is excellent.
d represents a molar ratio of element M among the total metals excluding lithium in the lithium nickel-based composite oxide, wherein d may satisfy 0≤d≤0.08, 0≤d≤0.05, or 0≤d≤0.03.

Specifically, a, b, c, and d of Formula 1 may satisfy 0.80≤a<1, 0<b≤0.15, 0<c≤0.15, and 0≤d≤0.05, respectively.

Since resistivity of the positive electrode is formed low when the lithium nickel-based composite oxide is an NCM oxide containing all of nickel, cobalt, and manganese, the above-described phenomenon of reducing insulation properties due to an increase in the thickness of the electrode assembly becomes more evident, and thus, an effect resulting from configuring to satisfy Equation (1) may be maximized.

The lithium manganese-based composite oxide may be at least one selected from the group consisting of LiₚMn_{1-q}M^{a}_{q}A₂, LiₚMn₂O₄₋ᵣXᵣ, LiₚMn_{2-q}M^{a}_{q}M^{b}ᵣA₄, LiₚCO_{1-q}M^{a}_{q}A₂, LiₚCo_{1-q}M^{a}_{q}O₂₋ᵣXᵣ, LiₚNi_{1-q}M^{a}_{q}O₂₋ᵣXᵣ, LiₚNi_{1-q}Co_{q}O₂₋ᵣXᵣ, LiₚNi_{1-q-r}Co_{q}M^{a}ᵣA_{w}, LiₚNi_{1-q-r}CO_{q}M^{a}ᵣO₂₋ᵣX_{w}, LiₚNi_{1-q-r}Mn_{q}M^{a}ᵣA_{w}, and LiₚNi_{1-q-r}Mn_{q}M^{a}ᵣO_{2-w}X_{w}, wherein p, q, r, and w satisfy 0.95≤p≤1.6, 0≤q≤1, 0≤r≤1, and 0≤w≤2, respectively, M^{a} and M^{b} are the same as or different from each other and are one or more elements selected from the group consisting of Mg, Al, Co, potassium (K), sodium (Na), Ca, silicon (Si), Ti, tin (Sn), V, germanium (Ge), Ga, B, arsenic (As), Zr, Mn, Cr, Fe, Sr, V, and rare earth elements, A is at least one element selected from the group consisting of oxygen (O), fluorine (F), sulfur (S), and phosphorus (P), and X is at least one element selected from the group consisting of F, S, and P.

Also, the lithium iron phosphate-based composite oxide may be represented by Formula 2 below.

LiFe₁₋ₖM^{c}ₖPO₄ [Formula 2]

In Formula 2,
M^{c} is at least one selected from Ni, Co, Mn, Al, Mg, Y, Zn, In, ruthenium (Ru), Sn, antimony (Sb), Ti, tellurium (Te), Nb, Mo, Cr, Zr, W, iridium (Ir), and V, and
0≤k<1.

The negative electrode active material layer may include a negative electrode active material, for example, a carbonaceous material such as graphite; metals or alloys composed of the metals; oxides of the metals; and composites of the metals and carbon, and may further include a conductive agent and/or a binder, if necessary. Various materials commonly used in the preparation of a secondary battery may be used without limitation as the negative electrode active material, the conductive agent, and the binder.

Conventional porous polymer films typically used as a separator, for example, polyolefin-based porous polymer films, such as an ethylene homopolymer, a propylene homopolymer, an ethylene/butene copolymer, an ethylene/hexene copolymer, and an ethylene/methacrylate copolymer, may be used alone or in a laminated form as the separator. Also, a polyolefin-based porous polymer film coated with inorganic particles (e.g., Al₂O₃) or a typical porous nonwoven fabric, for example, a nonwoven fabric formed of high melting point glass fibers or polyethylene terephthalate fibers may be used, but is not limited thereto.

### Electrolyte

In an aspect of the present disclosure, as the electrolyte, any electrolyte, in which lithium ions generated by an electrochemical reaction at the electrode during charge and discharge may move, may be used without limitation, and for example, an electrolyte, in which a lithium salt is dissolved in a non-aqueous organic solvent, may be used.

The lithium salt may be used without particular limitation as long as it is a compound capable of providing lithium ions used in the lithium secondary battery. Specifically, LiPF₆, LiCO₄, LiAsF₆, LiBF₄, LiSbF₆, LiAlO₂, LiAlCl₄, LiCF₃SO₃, LiC₄F₉SO₃, LiN(C₂F₅SO₃)₂, LiN(C₂F₅SO₂)₂, LiN(CF₃SO₂)₂, LiCl, LiI, or LiB(C₂O₄)₂ may be used as the lithium salt. A concentration of the lithium salt may be appropriately changed within a normally usable range, but the lithium salt may be used in a concentration range of 0.1 M to 5.0 M, preferably, 0.1 M to 3.0 M.

Any non-aqueous organic solvent may be used as the non-aqueous organic solvent without particular limitation so long as it may function as a medium through which ions involved in an electrochemical reaction of the battery may move. For example, a cyclic carbonate-based solvent, such as ethylene carbonate (EC), propylene carbonate (PC), and vinylene carbonate, a linear carbonate-based organic solvent such as dimethyl carbonate (DMC), diethyl carbonate (DEC), dipropyl carbonate, and ethyl methyl carbonate (EMC), or a mixed organic solvent thereof may be used.

The secondary battery may be used in various devices. For example, the secondary battery may be used in electric bicycles or electric cars such as electric vehicles and hybrid electric vehicles (HEVs).

Thus, according to another aspect of the present disclosure, a battery module including the secondary battery as a unit cell and a battery pack including the battery module are provided.

The battery module or the battery pack may be used as a power source of at least one medium and large sized device of a power tool; electric cars including an electric vehicle (EV), a hybrid electric vehicle, and a plug-in hybrid electric vehicle (PHEV); or a power storage system.

Hereinafter, the present disclosure will be described in detail, according to specific examples.

### Examples and Comparative Examples: Preparation of Battery Cases

### Example 1

A first polymer layer with a thickness of 150 μm was formed by sequentially bonding a polyethylene terephthalate (PET) film with a width of 266 mm, a length of 50 m, and a thickness of 50 μm and a nylon film with a width of 266 mm, a length of 50 m, and a thickness of 100 μm to one surface of an aluminum alloy thin film with a width of 266 mm, a length of 50 m, and a thickness of 250 μm using a urethane adhesive via a dry lamination method.

Next, a pouch film laminate was prepared by forming a 100 μm thick sealant layer (second polymer layer) by melting cast polypropylene (CPP) at a high temperature and then co-extruding it on a surface opposite to the surface of the aluminum alloy thin film on which the first polymer layer was formed. A total thickness of the pouch film laminate was 500 μm.

After the pouch film laminate was cut to a size of 130 mm×266 mm, drawing was performed in a forming device having a forming part with a size of 100 mm×216 mm to prepare a 1-cup type battery case including a cup portion with a depth of 2 mm. Corners and edges of a punch and the forming part of the forming device were filleted, the corner of the punch had a curvature of 2 mm, the edge thereof had a curvature of 1 mm, the corner of the forming part had a curvature of 2.3 mm, and the edge thereof had a curvature of 1 mm. In addition, clearance of the punch and the forming part was 0.3 mm.

### Examples 2 to 34 and Comparative Examples 1 to 18

Battery cases were prepared by using the same process as Example 1 except that the depth of the cup portion, the thickness of the polymer layer, and a thickness of a gas barrier layer were changed as shown in Table 1 below.

### Experimental Examples

### Experimental Example 1: Corrosion Evaluation

A stacked-type electrode assembly having an overall length of 210 mm and an overall width of 95 mm was prepared by alternatingly stacking a positive electrode including Li [Ni_{0.8}Co_{0.1}Mn_{0.1}]O₂, as a positive electrode active material, and a negative electrode including graphite, as a negative electrode active material, with a safety reinforced separator (SRS) disposed therebetween. In this case, the electrode assemblies were prepared in seven thicknesses: 1.9 mm, 3.9 mm, 5.9 mm, 7.9 mm, 9.9 mm, 11.9 mm, and 13.9 mm, and the electrode assemblies with different thicknesses were used depending on the depth of the cup portion of the battery case, as shown in Table 1 below.

After the electrode assembly was accommodated in the cup portion of each of the battery cases prepared in Examples 1 to 34 and Comparative Examples 1 to 18, an electrolyte solution, which was prepared by dissolving 1.0 M LiPF₆ in an organic solvent in which ethylene carbonate (EC) and ethyl methyl carbonate (EMC) were mixed in a volume ratio of 30:70, was injected, the battery case was then sealed, and a formation process was performed to prepare a pouch type secondary battery.

After preparing 10 secondary batteries each corresponding to each of the examples and the comparative examples, the prepared secondary batteries were charged at a constant current of 0.33 C-rate to 4.2 V in a room-temperature chamber at 25 °C and then discharged at a constant current of 0.33 C to 2.5 V. Next, charging and discharging were repeated 1,000 times under the same conditions as above, cell appearance inspection was performed to confirm the number of corroded cells among 10 cells, and the results thereof are listed in Table 1 below.

TABLE 1

| | | Electrode | Cup | | | | | Ga barrier |
|---|---|---|---|---|---|---|---|---|
| | Pouch | assembly | portion | Polymer Layer thickness (μm) | | | | layer |
| | thickness | thickness | depth | First | First | | | thickness |
| | (μm, P) | (mm, T) | (mm, C) | (PET) | (Nylon) | Second | Total | (μm) |
| Example 1 | 500 | 1.9 | 2 | 50 | 100 | 100 | 250 | 250 |
| Example 2 | | 3.9 | 4 | 50 | 100 | 100 | 250 | 250 |
| Example 3 | | 5.9 | 6 | 50 | 100 | 100 | 250 | 250 |
| Example 4 | | 7.9 | 8 | 50 | 100 | 100 | 250 | 250 |
| Example 5 | | 9.9 | 10 | 50 | 100 | 100 | 250 | 250 |
| Example 6 | | 11.9 | 12 | 50 | 100 | 100 | 250 | 250 |
| Example 7 | | 13.9 | 14 | 50 | 100 | 100 | 250 | 250 |
| Example 8 | 300 | 1.9 | 2 | 20 | 40 | 90 | 150 | 150 |
| Example 9 | | 3.9 | 4 | 20 | 40 | 90 | 150 | 150 |
| Example 10 | | 5.9 | 6 | 20 | 40 | 90 | 150 | 150 |
| Example 11 | | 7.9 | 8 | 20 | 40 | 90 | 150 | 150 |
| Example 12 | | 9.9 | 10 | 20 | 40 | 90 | 150 | 150 |
| Example 13 | | 11.9 | 12 | 20 | 40 | 90 | 150 | 150 |
| Example 14 | | 13.9 | 14 | 20 | 40 | 90 | 150 | 100 |
| Example 15 | 213 | 1.9 | 2 | 13 | 20 | 80 | 113 | 100 |
| Example 16 | | 3.9 | 4 | 13 | 20 | 80 | 113 | 100 |
| Example 17 | | 5.9 | 6 | 13 | 20 | 80 | 113 | 100 |
| Example 18 | | 7.9 | 8 | 13 | 20 | 80 | 113 | 100 |
| Example 19 | | 9.9 | 10 | 13 | 20 | 80 | 113 | 100 |
| Comparat. | | 11.9 | 12 | 13 | 20 | 80 | 113 | 100 |
| Example 1 | | | | | | | | |
| Comparat. | | 13.9 | 14 | 13 | 20 | 80 | 113 | 100 |
| Example 2 | | | | | | | | |
| Example 20 | 183 | 1.9 | 2 | 13 | 20 | 65 | 98 | 85 |
| Example 21 | | 3.9 | 4 | 13 | 20 | 65 | 98 | 85 |
| Example 22 | | 5.9 | 6 | 13 | 20 | 65 | 98 | 85 |
| Example 23 | | 7.9 | 8 | 13 | 20 | 65 | 98 | 85 |
| Comparat. | | 9.9 | 10 | 13 | 20 | 65 | 98 | 85 |
| Example 3 | | | | | | | | |
| Comparat. | | 11.9 | 12 | 13 | 20 | 65 | 98 | 85 |
| Example 4 | | | | | | | | |
| Comparat. | | 13.9 | 14 | 13 | 20 | 65 | 98 | 85 |
| Example 5 | | | | | | | | |
| Example 24 | | 9.9 | 10 | 8 | 15 | 60 | 83 | 100 |
| Example 25 | | 11.9 | 12 | 8 | 15 | 60 | 83 | 100 |
| Example 26 | | 13.9 | 14 | 8 | 15 | 50 | 73 | 110 |
| Comparat. | | 9.9 | 10 | 18 | 25 | 60 | 103 | 80 |
| Example 6 | | | | | | | | |
| Comparat. | | 11.9 | 12 | 18 | 25 | 60 | 103 | 80 |
| Example 7 | | | | | | | | |
| Comparat. | | 13.9 | 14 | 18 | 25 | 60 | 103 | 80 |
| Example 8 | | | | | | | | |
| Example 27 | 153 | 1.9 | 2 | 12 | 20 | 50 | 82 | 71 |
| Example 28 | | 3.9 | 4 | 12 | 20 | 50 | 82 | 71 |
| Example 29 | | 5.9 | 6 | 12 | 20 | 50 | 82 | 71 |
| Comparat. | | 7.9 | 8 | 12 | 20 | 50 | 82 | 71 |
| Example 9 | | | | | | | | |
| Comparat. | | 9.9 | 10 | 12 | 20 | 50 | 82 | 71 |
| Example 10 | | | | | | | | |
| Comparat. | | 11.9 | 12 | 12 | 20 | 50 | 82 | 71 |
| Example 11 | | | | | | | | |
| Comparat. | | 13.9 | 14 | 12 | 20 | 50 | 82 | 71 |
| Example 12 | | | | | | | | |
| Example 30 | | 7.9 | 8 | 8 | 20 | 40 | 68 | 85 |
| Example 31 | | 9.9 | 10 | 8 | 20 | 40 | 68 | 85 |
| Comparat. | | 7.9 | 8 | 8 | 25 | 60 | 93 | 60 |
| Example 13 | | | | | | | | |
| Comparat. | | 9.9 | 10 | 8 | 25 | 60 | 93 | 60 |
| Example 14 | | | | | | | | |
| Example 32 | 120 | 1.9 | 2 | 9 | 15 | 40 | 64 | 56 |
| Example 33 | | 3.9 | 4 | 9 | 15 | 40 | 64 | 56 |
| Example 34 | | 5.9 | 6 | 9 | 15 | 40 | 64 | 56 |
| Comparat. | | 7.9 | 8 | 9 | 15 | 40 | 64 | 56 |
| Example 15 | | | | | | | | |
| Comparat. | | 9.9 | 10 | 9 | 15 | 40 | 64 | 56 |
| Example 16 | | | | | | | | |
| Comparat. | | 11.9 | 12 | 9 | 15 | 40 | 64 | 56 |
| Example 17 | | | | | | | | |
| Comparat. | | 13.9 | 14 | 9 | 15 | 40 | 64 | 56 |
| Example 18 | | | | | | | | |

| | | | | | | | The |
|---|---|---|---|---|---|---|---|
| | | | K of | | S of | | number of |
| | | | Equation | Whether | Equation | Whether | corroded |
| | D | P/C | (1) | K ≥ 63 | (2) | S ≥ 37 | cells |
| Example 1 | 1 | 250.0 | 300 | ◯ | 283.2 | ◯ | 0/10 |
| Example 2 | 1 | 125.0 | 175 | ◯ | 148.2 | ◯ | 0/10 |
| Example 3 | 1 | 83.3 | 133.3 | ◯ | 104.7 | ◯ | 0/10 |
| Example 4 | 1 | 62.5 | 112.5 | ◯ | 83.3 | ◯ | 0/10 |
| Example 5 | 1 | 50.0 | 100 | ◯ | 70.5 | ◯ | 0/10 |
| Example 6 | 1 | 41.7 | 91.7 | ◯ | 62.0 | ◯ | 0/10 |
| Example 7 | 1 | 35.7 | 85.7 | ◯ | 56.0 | ◯ | 0/10 |
| Example 8 | 1 | 150.0 | 200 | ◯ | 177.9 | ◯ | 0/10 |
| Example 9 | 1 | 75.0 | 125 | ◯ | 96.9 | ◯ | 0/10 |
| Example 10 | 1 | 50.0 | 100 | ◯ | 70.8 | ◯ | 0/10 |
| Example 11 | 1 | 37.5 | 87.5 | ◯ | 58.0 | ◯ | 0/10 |
| Example 12 | 1 | 30.0 | 80 | ◯ | 50.3 | ◯ | 0/10 |
| Example 13 | 1 | 25.0 | 75 | ◯ | 45.2 | ◯ | 0/10 |
| Example 14 | 1 | 21.4 | 71.4 | ◯ | 41.6 | ◯ | 0/10 |
| Example 15 | 0.88 | 106.5 | 150.7 | ◯ | 129.8 | ◯ | 0/10 |
| Example 16 | 0.88 | 53.3 | 97.5 | ◯ | 72.3 | ◯ | 0/10 |
| Example 17 | 0.88 | 35.5 | 79.7 | ◯ | 53.8 | ◯ | 0/10 |
| Example 18 | 0.88 | 26.6 | 70.9 | ◯ | 44.7 | ◯ | 0/10 |
| Example 19 | 0.88 | 21.3 | 65.5 | ◯ | 39.2 | ◯ | 0/10 |
| Comparat. | 0.88 | 17.8 | 62 | X | 35.6 | X | 1/10 |
| Example 1 | | | | | | | |
| Comparat. | 0.88 | 15.2 | 59.5 | X | 33.0 | X | 2/10 |
| Example 2 | | | | | | | |
| Example 20 | 0.87 | 91.5 | 134.9 | ◯ | 113.7 | ◯ | 0/10 |
| Example 21 | 0.87 | 45.8 | 89.1 | ◯ | 64.3 | ◯ | 0/10 |
| Example 22 | 0.87 | 30.6 | 73.9 | ◯ | 48.4 | ◯ | 0/10 |
| Example 23 | 0.87 | 22.9 | 66.2 | ◯ | 40.5 | ◯ | 0/10 |
| Comparat. | 0.87 | 18.3 | 61.7 | X | 35.8 | X | 1/10 |
| Example 3 | | | | | | | |
| Comparat. | 0.87 | 15.3 | 58.6 | X | 32.7 | X | 2/10 |
| Example 4 | | | | | | | |
| Comparat. | 0.87 | 13.1 | 56.4 | X | 30.5 | X | 2/10 |
| Example 5 | | | | | | | |
| Example 24 | 1.20 | 18.3 | 87.5 | ◯ | 42.6 | ◯ | 0/10 |
| Example 25 | 1.20 | 15.3 | 75.5 | ◯ | 39.5 | ◯ | 0/10 |
| Example 26 | 1.51 | 13.1 | 88.4 | ◯ | 43.3 | ◯ | 0/10 |
| Comparat. | 0.78 | 18.3 | 57.1 | X | 34.0 | X | 2/10 |
| Example 6 | | | | | | | |
| Comparat. | 0.78 | 15.3 | 54.1 | X | 30.9 | X | 3/10 |
| Example 7 | | | | | | | |
| Comparat. | 0.78 | 13.1 | 51.9 | X | 28.7 | X | 3/10 |
| Example 8 | | | | | | | |
| Example 27 | 0.87 | 76.5 | 119.8 | ◯ | 97.8 | ◯ | 0/10 |
| Example 28 | 0.87 | 38.3 | 81.5 | ◯ | 56.5 | ◯ | 0/10 |
| Example 29 | 0.87 | 25.5 | 68.8 | ◯ | 43.2 | ◯ | 0/10 |
| Comparat. | 0.87 | 19.1 | 62.4 | X | 36.7 | X | 1/10 |
| Example 9 | | | | | | | |
| Comparat. | 0.87 | 15.3 | 58.6 | X | 32.8 | X | 2/10 |
| Example 10 | | | | | | | |
| Comparat. | 0.87 | 12.8 | 56 | X | 30.2 | X | 3/10 |
| Example 11 | | | | | | | |
| Comparat. | 0.87 | 10.9 | 54.2 | X | 28.3 | X | 4/10 |
| Example 12 | | | | | | | |
| Example 30 | 1.25 | 19.1 | 81.6 | ◯ | 44.4 | ◯ | 0/10 |
| Example 31 | 1.25 | 15.3 | 77.8 | ◯ | 40.5 | ◯ | 0/10 |
| Comparat. | 0.65 | 19.1 | 51.4 | X | 32.3 | X | 2/10 |
| Example 13 | | | | | | | |
| Comparat. | 0.65 | 15.3 | 47.6 | X | 28.4 | X | 3/10 |
| Example 14 | | | | | | | |
| Example 32 | 0.88 | 60.0 | 103.8 | ◯ | 80.7 | ◯ | 0/10 |
| Example 33 | 0.88 | 30.0 | 73.8 | ◯ | 48.3 | ◯ | 0/10 |
| Example 34 | 0.88 | 20.0 | 63.8 | ◯ | 37.8 | ◯ | 0/10 |
| Comparat. | 0.88 | 15.0 | 58.8 | X | 32.7 | X | 1/10 |
| Example 15 | | | | | | | |
| Comparat. | 0.88 | 12.0 | 55.8 | X | 29.6 | X | 3/10 |
| Example 16 | | | | | | | |
| Comparat. | 0.88 | 10.0 | 53.8 | X | 27.6 | X | 4/10 |
| Example 17 | | | | | | | |
| Comparat. | 0.88 | 8.6 | 52.3 | X | 26.1 | X | 5/10 |
| Example 18 | | | | | | | |

Through the results of Table 1, it may be confirmed that no corrosion occurred at all in the secondary batteries having an S value of 37.0 or more by using the battery cases of Examples 1 to 34 in which the thickness of the battery case, the depth of the cup portion, the thickness of the gas barrier layer, and the thickness of the polymer layer were adjusted to satisfy K≥63.0, but corrosion occurred in one or more cells for the secondary batteries having an S value of less than 37.0 by using the battery cases of Comparative Examples 1 to 18 in which K<63.0.

That is, it may be confirmed that there was an effect of improving corrosion resistance of the pouch type secondary battery by adjusting the K value of Equation (1) to 63.0 or more.

### Experimental Example 2: Cell Performance Evaluation

Among the secondary batteries prepared in Experimental Example 1, the secondary batteries having a thickness of the electrode assembly of 7 mm or more (Examples 4 to 7, 11 to 14, 18, 19, 23 to 26, 30, and 31 and Comparative Examples 1 to 18) were charged at a constant current of 0.33 C-rate to 4.2 V in a room-temperature chamber at 25 °C and then discharged at a constant current of 0.33 C to 2.5 V to confirm initial capacity and energy density. The energy density was calculated by multiplying discharge capacity of the cell by an average voltage and then dividing it by a unit volume, and the average voltage was a value obtained by dividing a curve integral value of a capacity-voltage profile by capacity. Average values of the initial capacities and the energy densities, which were confirmed in 10 cells, are listed in Table 2 below.

Next, charging and discharging were repeated 1,000 times under the same conditions as above, capacity retention after 1,000 charge and discharge cycles relative to the initial capacity was checked for each of the 10 cells, and an average value thereof was then calculated and listed in Table 2 below.

TABLE 2

| | | Electrode | | | | | | | |
|---|---|---|---|---|---|---|---|---|---|
| | Pouch | assembly | K of | | S of | | Initial | Energy | Capacity |
| | thickness | thickness | Equation | Whether | Equation | Whether | capacity | density | retention |
| | (μm, P) | (mm, T) | (1) | K ≥ 63 | (2) | S ≥ 37 | (mAh) | (Wh/L) | (%) |
| Example 4 | 500 | 7.9 | 112.5 | ◯ | 83.3 | ◯ | 31 | 353 | 86 |
| Example 5 | | 9.9 | 100 | ◯ | 70.5 | ◯ | 38.9 | 361 | 88 |
| Example 6 | | 11.9 | 91.7 | ◯ | 62.0 | ◯ | 46.6 | 367 | 91 |
| Example 7 | | 13.9 | 85.7 | ◯ | 56.0 | ◯ | 54.5 | 371 | 94 |
| Example 11 | 300 | 7.9 | 87.5 | ◯ | 58.0 | ◯ | 31 | 370 | 86 |
| Example 12 | | 9.9 | 80 | ◯ | 50.3 | ◯ | 38.9 | 375 | 88 |
| Example 13 | | 11.9 | 75 | ◯ | 45.2 | ◯ | 46.6 | 379 | 91 |
| Example 14 | | 13.9 | 71.4 | ◯ | 41.6 | ◯ | 54.5 | 381 | 94 |
| Example 18 | 213 | 7.9 | 70.9 | ◯ | 44.6 | ◯ | 31 | 378 | 86 |
| Example 19 | | 9.9 | 65.5 | ◯ | 39.1 | ◯ | 38.9 | 381 | 88 |
| Comparative | | 11.9 | 62 | X | 35.5 | X | 40.6 | 384 | 84 |
| Example 1 | | | | | | | | | |
| Comparative | | 13.9 | 59.5 | X | 32.9 | X | 54.5 | 386 | 80 |
| Example 2 | | | | | | | | | |
| Example 23 | 183 | 7.9 | 66.2 | ◯ | 40.6 | ◯ | 31 | 380 | 86 |
| Comparative | | 9.9 | 61.7 | X | 35.9 | X | 38.9 | 384 | 83 |
| Example 3 | | | | | | | | | |
| Comparative | | 11.9 | 58.6 | X | 32.8 | X | 46.6 | 386 | 79 |
| Example 4 | | | | | | | | | |
| Comparative | | 13.9 | 56.4 | X | 30.6 | X | 54.5 | 387 | 79 |
| Example 5 | | | | | | | | | |
| Example 24 | | 9.9 | 78.5 | ◯ | 42.5 | ◯ | 38.9 | 384 | 88 |
| Example 25 | | 11.9 | 75.5 | ◯ | 39.4 | ◯ | 46.6 | 386 | 91 |
| Example 26 | | 13.9 | 88.4 | ◯ | 43.4 | ◯ | 54.5 | 387 | 94 |
| Comparative | | 9.9 | 57.1 | X | 34.1 | X | 38.9 | 384 | 75 |
| Example 6 | | | | | | | | | |
| Comparative | | 11.9 | 54.1 | X | 31.0 | X | 46.6 | 386 | 71 |
| Example 7 | | | | | | | | | |
| Comparative | | 13.9 | 51.9 | X | 28.8 | X | 54.5 | 387 | 71 |
| Example 8 | | | | | | | | | |
| Comparative | 153 | 7.9 | 62.4 | X | 36.8 | X | 31 | 383 | 80 |
| Example 9 | | | | | | | | | |
| Comparative | | 9.9 | 58.6 | X | 32.9 | X | 38.9 | 386 | 76 |
| Example 10 | | | | | | | | | |
| Comparative | | 11.9 | 56 | X | 30.3 | X | 46.6 | 388 | 72 |
| Example 11 | | | | | | | | | |
| Comparative | | 13.9 | 54.2 | X | 28.4 | X | 54.5 | 389 | 68 |
| Example 12 | | | | | | | | | |
| Example 30 | | 7.9 | 81.6 | ◯ | 44.4 | ◯ | 31 | 383 | 86 |
| Example 31 | | 9.9 | 77.8 | ◯ | 40.5 | ◯ | 38.9 | 386 | 88 |
| Comparative | | 7.9 | 51.4 | X | 32.4 | X | 31 | 383 | 76 |
| Example 13 | | | | | | | | | |
| Comparative | | 9.9 | 47.6 | X | 28.5 | X | 38.9 | 386 | 72 |
| Example 14 | | | | | | | | | |
| Comparative | 120 | 7.9 | 58.8 | X | 32.8 | X | 31 | 386 | 80 |
| Example 15 | | | | | | | | | |
| Comparative | | 9.9 | 55.8 | X | 29.7 | X | 38.9 | 388 | 72 |
| Example 16 | | | | | | | | | |
| Comparative | | 11.9 | 53.8 | X | 27.7 | X | 46.6 | 390 | 68 |
| Example 17 | | | | | | | | | |
| Comparative | | 13.9 | 52.3 | X | 26.2 | X | 54.5 | 391 | 60 |
| Example 18 | | | | | | | | | |

Through the results of Table 2, it may be confirmed that the secondary batteries using the battery cases of the examples satisfying K≥63.0 satisfied S≥37.0 and showed a tendency for initial capacity to increase and lifetime to improve as the depth of the cup portion was increased, that is, as the electrode assembly became thicker.

In contrast, with respect to the secondary batteries using the battery cases of the comparative examples in which K<63.0, it may be confirmed that S<37.0 and initial capacity increased as the thickness of the electrode assembly was increased, but life characteristics were degraded.

Since a force generated by expansion/contraction of the electrode assembly during operation of the battery was increased as the thickness of the electrode assembly was increased, a level of durability required for the battery case was also increased, but unlike the battery cases prepared in the examples, the battery cases prepared in the comparative examples did not satisfy this level.

That is, it may be confirmed that there was an effect of improving life characteristics of the pouch type secondary battery by adjusting the K value of Equation (1) to 63.0 or more.

1. A battery case comprising:
a first polymer layer, a second polymer layer, and a gas barrier layer disposed between the first polymer layer and the second polymer layer; and
comprising at least one cup portion curved in one direction, wherein a K value according to a following Equation (1) is 63.0 or more:
K=P/C+50D (1), wherein:
P is a thickness value of the battery case which is measured in μm;
C is a depth value of the cup portion which is measured in mm; and
D is a ratio of a thickness of the gas barrier layer to a total thickness of the first polymer layer and the second polymer layer.

2. The battery case of claim 1, wherein P is from 100 μm to 1,000 μm.

3. The battery case of claim 1, wherein C is from 1 mm to 70 mm.

4. The battery case of claim 1, wherein P/C is 19.5 or more.

5. The battery case of claim 1, wherein the first polymer layer has a thickness of from 10 μm to 300 μm.

6. The battery case of claim 1, wherein the second polymer layer has a thickness of from 10 μm to 300 μm.

7. The battery case of claim 1, wherein the gas barrier layer has a thickness of from 50 μm to 900 μm.

8. The battery case of claim 1, wherein the gas barrier layer comprises at least one metal selected from stainless steel (SUS), nickel (Ni), iron (Fe), cobalt (Co), chromium (Cr), molybdenum (Mo), tantalum (Ta), tungsten (W), titanium (Ti), or rhenium (Re); or comprises an alloy of the metal and aluminum (Al).

9. The battery case of claim 1, wherein D is 0.80 or more.

10. A secondary battery comprising:
an electrode assembly including a positive electrode, a negative electrode, and a separator disposed between the positive electrode and the negative electrode; an electrolyte; and the battery case of claim 1,
wherein the electrode assembly and the electrolyte are accommodated in a cup portion of the battery case.

11. The secondary battery of claim 10, wherein the secondary battery has an S value according to a following Equation (2) of 37.0 or more:
S=P/T×N+20D (2), wherein:
P is as defined in claim 1; T is a thickness value of the electrode assembly which is measured in mm, wherein, when two or more electrode assemblies are included, T is a sum of thickness values of the two or more electrode assemblies;
N is the number of cup portions in the battery case; and
D is as defined in claim 1.

12. The secondary battery of claim 10, wherein
T is from 1 mm to 150 mm.
